(19) United States
(12) Patent Application Publication
(10) Pub. No.: US 2002/0023028 A1
(43) Pub. Date: Feb. 21, 2002

(54) Retailing audio files in a fuel dispensing environment

(76) Inventors: Brian L. Quarendon, Hampshire (GB); Steven N. Terranova, Cary, NC (US)

Correspondence Address: WITHROW & TERRANOVA, P.L.L.C., P.O. BOX 1287, CARY, NC, 27512, US

(21) Appl. No.: 09/970,183

(22) Filed: Oct. 2, 2001

Related U.S. Application Data
(62) Division of application No. 09/483,079, filed on Jan. 14, 2000.

(51) Int. Cl. G06F 17/60

(52) U.S. Cl. 705/26

(57) ABSTRACT

A system for retailing music in a fueling environment includes a central server communicatively connected to a local server in the fueling environment. The central server downloads music for purchase to the local server. The local server communicates to fuel dispensers or music kiosks in the fueling environment. Consumers may purchase music from the music dispensers as part of a fueling transaction. The music is provided to the consumer wirelessly or through a portable data storage device.

### RELATED APPLICATIONS

The present application is related to concurrently filed, commonly invented, commonly assigned applications Ser. No. ______, entitled MULTISTAGE FORECOURT DATA ORDER AND/OR PURCHASE and Ser. No. ______, entitled MULTISTAGE DATA PURCHASE, both of which are hereby incorporated by reference.

### BACKGROUND OF THE INVENTION

1. Field of the Invention

The present invention is directed to a system enabling retail music transactions to occur in a fuel dispensing environment.

2. Description of the Related Art

Recorded music has evolved over the years from the early days including player piano scrolls to vinyl LPs, eight track tapes, magnetic tapes, and finally into the digital age. Recent years have seen digital music explode into the minds of the consuming public. The public initially rushed to purchase compact discs. Similarly, digital audio tapes had a brief peak in interest; and most recently, MP3 and similar digital file formats, such as WMA (Windows Media Audio), are becoming popular for use with or through a computer. Consumers are attracted to the digital format because of the clarity with which the music is replayed and the fact that the media on which the music is stored are not prone to degrade over time as do albums or tapes. Furthermore, while of great concern to the recording industry, copies made from digital originals typically are as pure and clear as the original, thus allowing someone to perpetuate the existence of the music within their personal library even if the underlying media on which the music is stored deteriorates.

In response to the proliferating digital formats, portable devices became available, allowing music consumers to keep the music in close proximity for listening at any time. The portable devices followed the release of the format closely. Initially, portable compact disc players appeared, then DAT players, and recently portable MP3 players. While the most recent MP3 devices seem to be limited to hand held units, it is expected that devices adapted to be played through a vehicle stereo system will emerge in due course.

Presently, formats such as MP3 are primarily intended for use through a computer, but portable storage media are also emerging as evidenced by SONY®'s announcement of its “MAGIC GATE MEMORY STICK” for use in its MS WALKMAN. Additionally, the presently preferred method to retail this music is through a computer, perhaps over the Internet, but it is to be expected that consumers, especially the computer illiterate, will demand alternative retail possibilities while preserving the features that make MP3 and its kin attractive to the audiophile.

In the fuel dispensing environment, many advances have been made to the fueling forecourt. Purchases are now possible through the fuel dispenser, as is Internet access, and other seemingly incongruous combinations of features. Several examples of such retail transactions available through a fuel dispenser are seen in the family of patents to Smith, including U.S. Pat. Nos. 5,914,654 and 5,806,018. However, the Smith patents have not provided a way to retail music to consumers through the fuel dispenser. As in-vehicle devices using new music formats become popular, it is expected that there will be an increasing demand for the ability to purchase easily a single song or the like in nonconventional retail environments such as a fueling environment.

### SUMMARY OF THE INVENTION

The present invention addresses the shortcomings of the prior art's ability to vend music in a fuel dispenser by providing a local server, or comparable computer, within the fueling environment. The local server is accessible by the computers located within the individual fuel dispensers within the fueling environment, or by other music vending kiosks within the fueling environment. A consumer may indicate through a user interface on the fuel dispenser or kiosk that she wishes to purchase a selected music file present within the memory of the local server.

In a first aspect, the music transaction is incorporated into the fueling transaction, and payment includes both costs.

In a second aspect, the music transaction is kept distinct from the fueling transaction, requiring a second payment authorization from a credit card, separate insertion of cash into a cash acceptor, or the like.

In a third aspect, the consumer may insert a portable storage medium into a music dispenser, which could be the fuel dispenser or separate kiosk, and have music downloaded to the portable storage medium. The portable storage medium may then be played by or uploaded into an appropriate device. In the preferred embodiment, the appropriate device would be an in-vehicle device.

In a fourth aspect, the consumer may possess a device including at least a receiver, and the music dispensers include at least a transmitter. The transmitter may “broadcast” the purchased music selection to the receiver, which may then record the received broadcast into an appropriate memory device, either portable or fixed. The device may be a smart card type device, magnetic storage medium, optical storage medium, a portable MP3 player, an in-vehicle stereo system with associated memory, or the like as needed.

In a fifth aspect, an in-vehicle computer may allow the consumer to purchase the music without ever getting out of the vehicle. This may be particularly helpful to handicapped individuals, passengers in the vehicle who do not need to get out of the vehicle, or individuals in a robotic fueling environment.

In a sixth aspect, music may be purchased at a first location, and the music actually received or downloaded at a second location. This multistage transaction may facilitate eliminating back-ups in the fuel dispenser lanes, or allow a consumer to efficiently download multiple songs while completing multiple transactions. Further, the initial order may be initiated when the consumer is not even physically present within the fueling environment, but rather while the consumer is driving towards the fueling environment. It is to be expected that various combinations of these aspects may be implemented at various locations, and to some extent, these aspects are cumulative, not mutually exclusive.

The local server or equivalent computer may be periodically updated to make sure that the songs available are the songs that are most likely to be sold, thereby attempting to maximize revenue generation from the endeavor. Songs that are not being sold may be deleted as needed to make room in the memory for the new songs. To this end a central server may be communicatively connected to a plurality of local servers and act as a central repository for all the music available through the fueling environments. Additionally, it is possible that the music be stored at the central server, or other remote computer and downloaded directly to the music dispenser.

### BRIEF DESCRIPTION OF THE DRAWINGS

FIG. 1 is a simplified drawing of a network used to supply music to a fueling environment;

FIG. 2 is a block diagram of a system to provide music from the local server to a music dispenser;

FIG. 3 is a simplified drawing of a first technique to transfer music to an in-vehicle device;

FIG. 4 is a simplified drawing of a second technique to transfer music to an in-vehicle device;

FIG. 5 is a simplified drawing of a third technique to transfer music to an in-vehicle device;

FIG. 6 is a schematic drawing illustrating multi-stage purchasing; and

FIG. 7 is a schematic drawing illustrating the different aspects of the present invention.

### DETAILED DESCRIPTION OF THE PREFERRED EMBODIMENTS

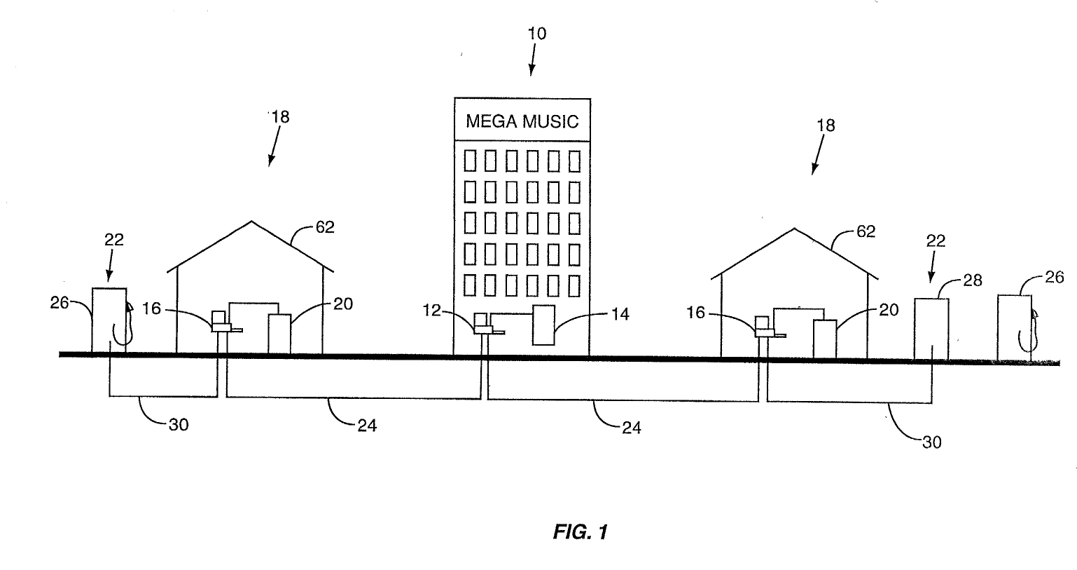

The present invention is directed to vending music in a fuel dispensing environment. Prior to introducing the methodology of the present invention, it will be helpful to explain components associated with the present invention. Turning now to FIG. 1, a central music repository 10 includes a central server 12 and a music memory unit 14. Central server 12 is communicatively coupled to a plurality of local servers 16, each located at different ones of a plurality fueling environments 18. Each local server 16 includes a memory device 20 and is communicatively coupled to at least one music dispenser 22.

In practice, the central music repository 10 is likely to be a copyright holding company such as ASCAP, BMI, a similar company, or a licensee thereof. The music memory unit 14 may be able to accommodate extremely large volumes of data, preferably in the terabyte category, and may additionally be expandable as needed to accommodate future music storage. Central server 12 may be connected to local servers 16 by the internet, a Wide Area Network (WAN), a wireless network or the like. For simplicity, the connection will be referred to as network 24. Network 24 may be a dedicated network conveying only information of interest to the present invention, a proprietary network, such as might carry information from a corporate headquarters to a plurality of franchisees, or a common network such as the Internet as needed or desired.

The local server 16 is preferably a computer and may be a site controller, such as the G-SITE®, sold by assignee of the present invention, or other comparable computer based server. The memory device 20 preferably accommodates approximately ten to twenty gigabytes of information, but may be expanded as needed or desired. As memory continues to become more affordable, it is expected that this value will become larger. Additionally, memory 20, while shown external to the local server 16, may in fact be incorporated into local server 16 if needed or desired to conserve space.

The music dispensers 22 may be positioned in the fueling environment 18 forecourt, or they may be associated with a particular building within the fueling environment 18. For example, the music dispenser 22 may be integrated into a fuel dispenser 26, an independent kiosk 28, a customer user interface associated with a quick serve restaurant, a customer user interface associated with a car wash unit, a customer user interface associated with a convenience store, or the like as needed or desired.

As would be expected, appropriate software to run the various computers, provide the appropriate communications and otherwise support the present invention may be installed on the appropriate computers. “Servers” are herein defined to be synonymous with the term computers. Likewise, a database in a memory unit that is accessed by remote computers is also to be included in the term server or computer. Still further, a distributed computer that has a central memory on which the music is stored should also be considered a server.

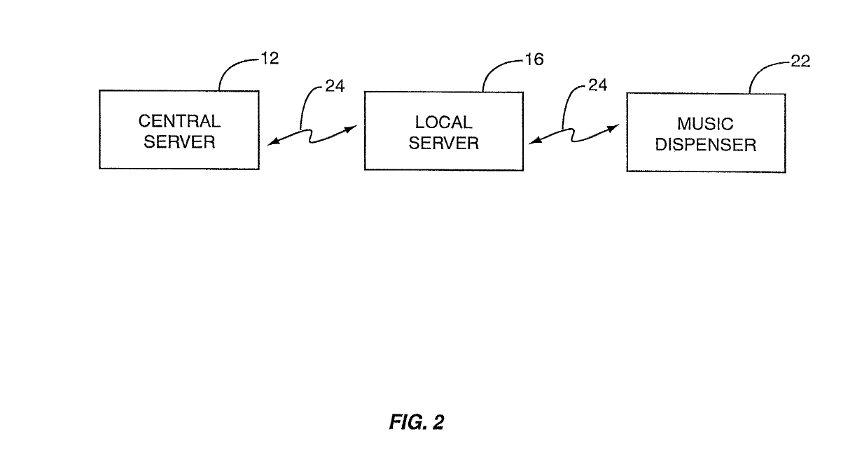

As shown in FIG. 1, the music dispensers 22 are connected by fixed lines 30 to local servers 16. However, it should be appreciated that the lines 30 maybe a wireless communications system 32, and network 24 may also be wireless as shown in FIG. 2. This substitution requires the addition of the appropriate transmitters and receivers. Additionally, since the data transferred in the present invention is presently typically on the order of fifty Mbytes for a typical MP3 file, broadband communications are desirable.

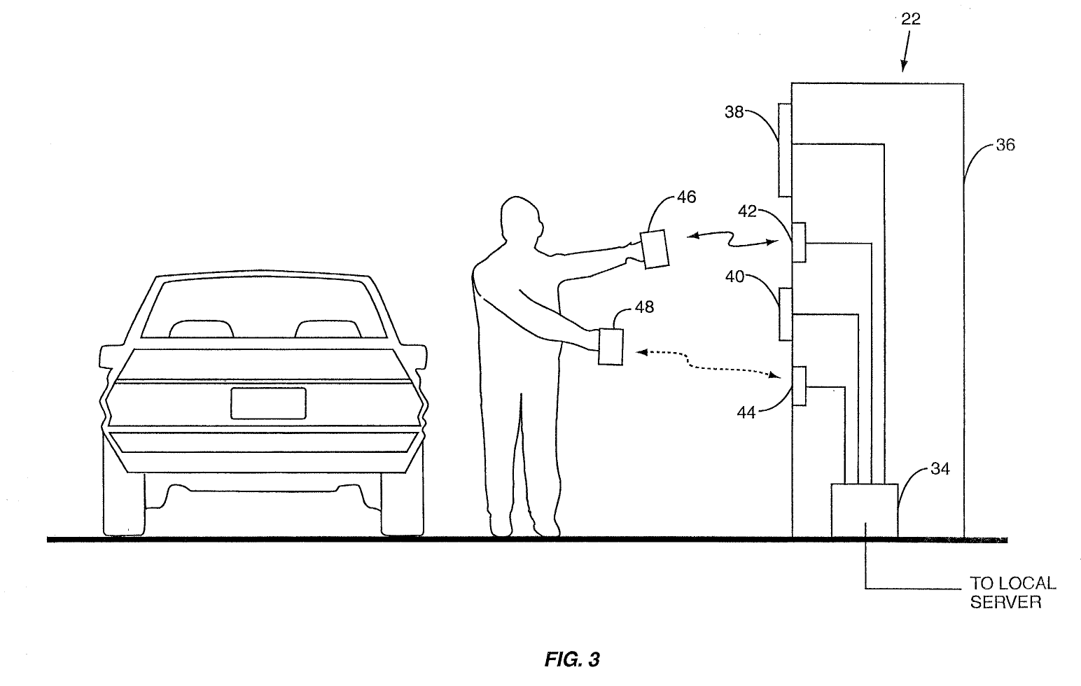

With these or equivalent communications systems in place, it is possible to vend music to a consumer in the fueling environment 18, as better seen in FIG. 3. Specifically, the music dispenser 22 includes a local controller 34 located within a housing 36. In the event that the music dispenser 22 is a fuel dispenser 26, the local controller 34 may be integrated into the control system of the fuel dispenser 26 and also act to authorize fueling transactions, fuel grade selection, vapor recovery, and the like. Music dispenser 22 may include a display 38 and a keypad 40. Equivalently, the display 38 and keypad 40 may be replaced by a touchscreen or the like as needed or desired. Additionally, the music dispenser 22 may include an RF transmitter 42 and a disk drive 44. While labeled a transmitter, transmitter 42 could equivalently be a full transceiver with transmit and receive capabilities. Additionally, it is possible that the local controller 34 includes sufficient memory therein to store music without resort to memory device 20.

A customer may have a portable playback device 46 with receiver capabilities, or perhaps even transceiver capabilities that communicates with the transmitter 42. Portable playback device 46 may, for example, be an MP3 player, a smart card, some other music player with a built in memory unit for recording thereon, or a music player with memory for downloading thereto. Alternatively, the customer may have a portable storage medium 48, such as a minidisk, a flash memory card, an IOMEGA clik disk, a CDR, the like or equivalent, which may inserted into disk drive 44 and is fully compatible therewith. Still further, the portable storage medium 48 may be generated within the music dispenser 22 on an as needed basis. Media 48 may be disposable or not as needed or desired.

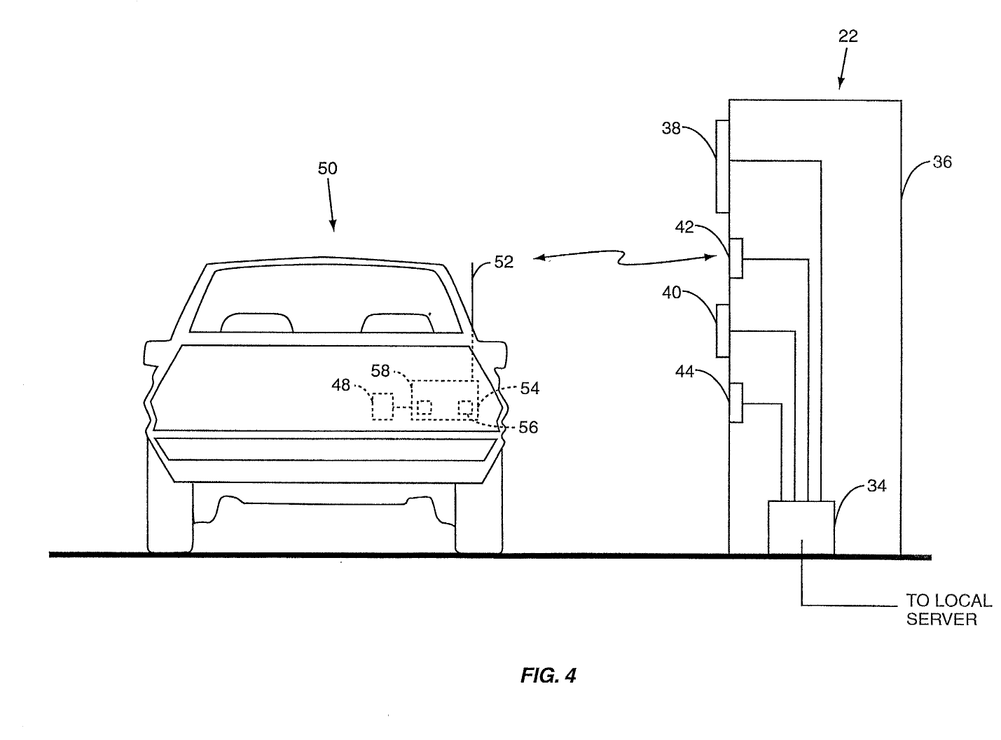

Additionally, the transmitter 42 may communicate directly to a vehicle 50, specifically through an antenna 52, as better seen in FIG. 4. Antenna 52 is communicatively coupled to an in-vehicle playback device 54 with associated memory 56. In-vehicle playback device 54 further may include a disk drive 58 that accommodates the portable storage medium 48 previously described. The portable playback device 46 may communicate with or be installed into the in-vehicle playback device 54. In-vehicle playback device 54 is preferably wired into the stereo system of the vehicle 50 and may serve multiple duties, such as radio, CD player, tape player, MP3 player or other audio format player as needed or desired. Thus, if the portable playback device 46 has downloaded music from the music dispenser 22, it may be reinstalled into the car stereo system and play as normal until needed for a future download or the like.

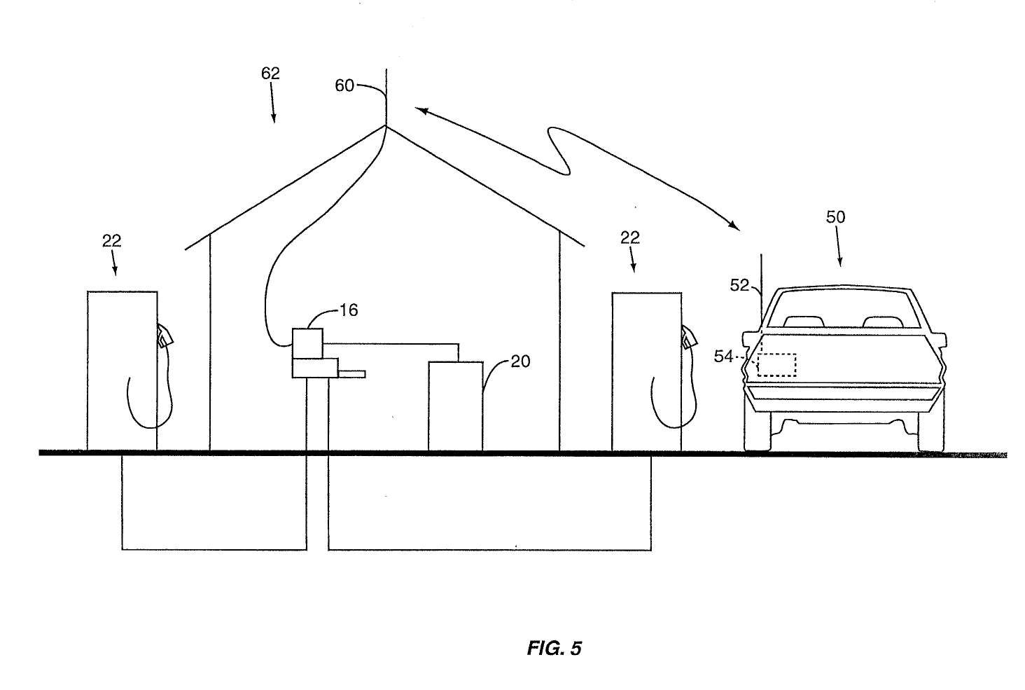

Further, an antenna 60 on the fueling station building 62 may broadcast to the antenna 52 on the vehicle 50, as shown in FIG. 5. Antenna 60 communicates with playback device 54 and stores received music files on memory 58.

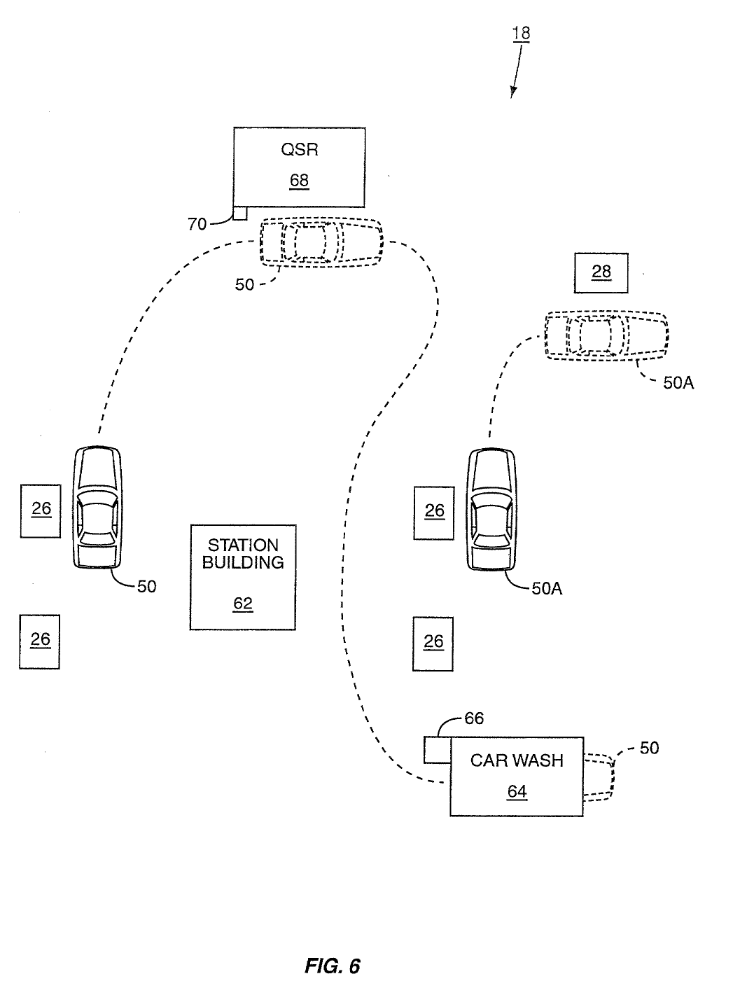

Still further, as seen in FIG. 6, it is possible that the music transaction may be completed from a plurality of locations. Specifically, a vehicle 50 may begin a transaction at a fuel dispenser 26. During the fueling transaction, the consumer may also arrange for other transactions, such as is disclosed in U.S. Pat. No. 5,956,259, which is hereby incorporated by reference. Payment is authorized for all the transaction and arrangements are made to send the music to the consumer. However, at this time, the fueling operation is complete, and the consumer is traveling to a second location within the fueling environment 18 forecourt. For example, if the consumer ordered several songs, the vehicle 50 may move to quick serve restaurant 68 proximate quick serve restaurant music dispenser 70 before the music dispenser in fuel dispenser 26 has finished downloading music to the vehicle 50, the portable device 46 or the storage medium 48.

While the consumer retrieves his food, music dispenser 70 attempts to complete the music transfer and transmits music for recording to the vehicle 50. If the music transfer is still not complete, but the consumer has requested a car wash, the vehicle 50 may then be moved to the car wash 64, proximate car wash music dispenser 66. Car wash music dispenser 66 finishes the music transfer while the car is being washed. In another example, the vehicle 50A begins the transaction and secures payment authorization at a fuel dispenser 26, but then receives all the music from a stand alone kiosk 28. Both of these are intended as examples, many variations are possible. It is easier for the consumer to receive the music transfer through the antenna 52, but at each station she could exit the vehicle 50 and use a portable device 46 or 48 with the music dispenser in question.

Additionally, as disclosed in the incorporated application Ser. No. ______, entitled MULTISTAGE DATA PURCHASE, the transaction may be initiated by a consumer in a vehicle in route to a music dispenser. In this event, the information retrieved according to the methodology of that application is music.

With the hardware now fully described, the methodology of the present invention may now be explored with greater ease. Initially, the central server 12 and memory 14 are stocked with music. This may comprise copying CDs into an MP3 format on memory 14, downloading MP3 files to memory 14 from an external source, or the like. While it is assumed that MP3 is the format of choice in terms of compressing the most music into the smallest memory, other existing and future formats may be equally viable and desirable, such as WMA or the like. At some point, a decision will be made that memory 14 and central server 12 are adequately supplied with music files, and they will be made available to the fueling environments 18.

Once the hardware is in place, a fueling environment 18 may elect to vend music to its fueling customers or other individuals who have reason to stop in the fueling environment 18. Local server 16 may contact via network 24 central server 12 and ask to download music to the memory 20. In instances where the network 24, or more specifically the central server 12, is accessible from a plurality of computers, both authorized to download and not authorized to download, appropriate security measures may be used to ensure that only authorized servers 16 download music from the central server 12. In the preferred embodiment, to conserve bandwidth, music is transmitted from the central server 12 to the local server 16 at non-peak usage times such as the middle of the night. This is especially true where the network 24 is the Internet. Additionally, since the network 24 may be used for other communications from the fueling environment 18, conservation of bandwidth is of concern.

Once music is downloaded to the memory 20, it becomes available for purchase through the music dispensers 22. It should be appreciated that music on the memory 20 will become dated, or unpopular, and it may be necessary to update it periodically. New music may be downloaded from the central server 12, again, preferably at non-peak times, and music that is not selling may be deleted, written over, or shuffled off into auxiliary memory. Memory constraints presently suggest that the non-selling music will be deleted, however, if memory continues to become more affordable, this may no longer be an issue, and the music files may accumulate as desired or needed.

Further, the local controller 34 within the music dispenser 22 may contain sufficient memory to store the music files therein. While this is presently not feasible given the economics of memory chips, it is certainly conceivable, and may be preferred at some later date.

Additionally, it is conceivable that when the music dispenser 22 receives a purchase order from a consumer, then at that time the music dispenser 22 retrieves the ordered music from the central server 12. At present this is not preferred because of the demands such data transfers place upon the networks 24 and 30, however, as bandwidth becomes more available for high speed data transfers, such an arrangement may become more feasible.

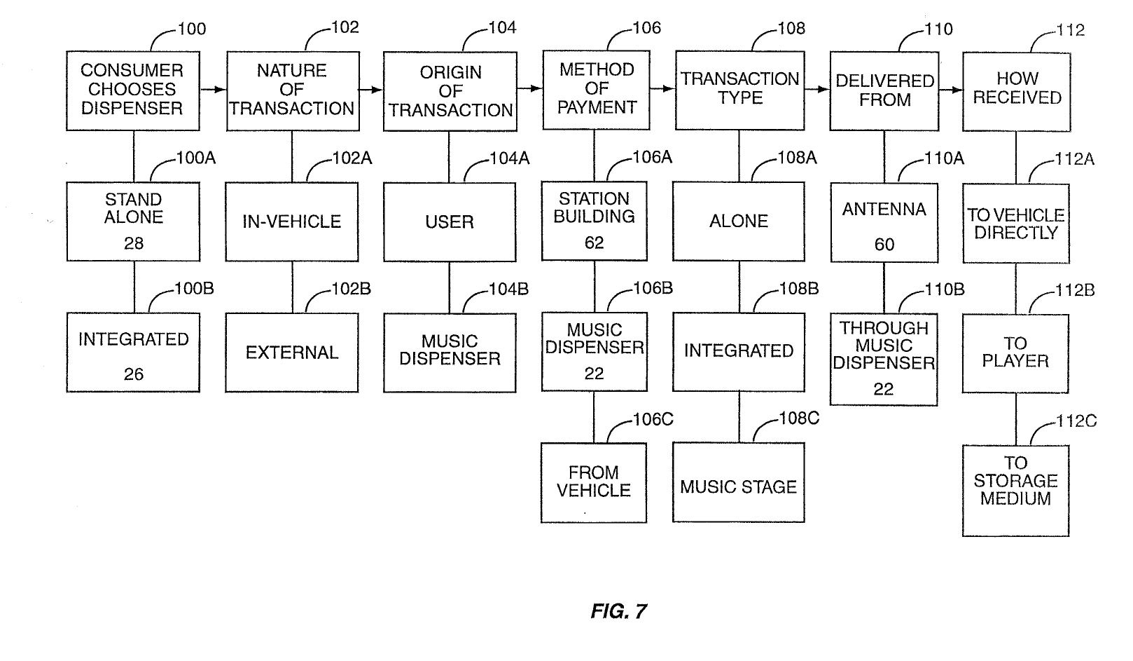

The actual purchasing and delivery of the music may take a number of different forms. A flow chart of the variants is seen in FIG. 7 The first decision is made by the consumer and concerns the type of dispenser 22 that the consumer approaches (block 100). Specifically, the consumer may approach a stand alone kiosk 28 (block 100A) within the fueling environment 18, or a music dispenser 22 that is integrated into another sales terminal, such as a fuel dispenser 26 (block 100B). This choice is obviously influenced by the needs of the consumer. If the consumer needs to purchase fuel, he is likely to approach a fuel dispenser 26. If the consumer needs to purchase something from a quick serve restaurant or car wash, then the consumer is likely to approach a music dispenser 22 integrated into the sales terminal associated with that particular forecourt feature. If however, the consumer heard a catchy tune on the radio and decided to make an impulse purchase, then the consumer may be likely to head straight to a stand alone kiosk 28.

The nature of the transaction must then be determined (block 102). Namely, the transaction may occur from within the vehicle 50 (block 102A) or external to the vehicle 50 (block 102B). That is, vehicles of the future are likely to have an in-vehicle computer integrated into the vehicle. This computer may control a number of things within the vehicle, but of particular concern is the fact that the computer may be operatively connected to a transceiver that may in turn be operatively connected to the antenna 52. Through this computer, a consumer may have a user interface that communicates effectively with the music dispenser 22 through the transceiver 42, whether the music dispenser is a dedicated music dispenser 28 or integrated into another device such as fuel dispenser 26. Glimmers of this functionality are starting to be seen in vehicle mounted transponders that automatically interact with fuel dispensers to authorize payment, select fuel grade and the like. The present invention takes this one step further and supports full bi-directional communication between the in-vehicle computer and the music dispenser 22. U.S. Pat. No. 5,914,654, which is hereby incorporated by reference, provides a good discussion of the possibilities and requirements of vehicle to external unit communication.

Alternatively, the transaction may be a bit more manual, and the consumer may interact directly with the music dispenser 22 through the display 38 and the keypad 40. This requires that the consumer exit the vehicle. This is not particularly unusual during a fueling transaction, as the consumer typically has to insert the nozzle into the fuel tank of the vehicle 50 prior to dispensing fuel. Note also robotic fueling seems just around the corner, and consumers may no longer have to exit the vehicle during a fueling transaction. In that event, it may be desirable to order music from the vehicle during the fueling transaction.

The next variant on the invention is the origin of the music transaction (block 104). A consumer may initiate the music purchase (block 104A), or the music dispenser 22 may query the user whether or not he wishes to purchase music at that time (block 104B).

Still another variant is the method of payment (block 106). Payment can be authorized at within the station building 62 (block 106A), the music dispenser 22 (block 106B), or from within the vehicle 50 (block 106C). As would be expected, cash, credit cards, debit cards, transponders, or the like may be used within the station building 62. Likewise, the music dispenser 22 may be equipped with a cash acceptor, a magnetic card reader, a wireless interrogator, or the like to facilitate payment acceptance at the music dispenser 22. In those instances wherein an in-vehicle transaction is occurring, it will be preferable to automate the transmission of payment information to the music dispenser 22, although there is nothing that precludes a person from leaning out his window in the vehicle and interacting with the music dispenser 22 in a fashion similar to an ATM, at least for payment authorization.

Yet another variant is whether or not the music sale is integrated into another transaction for the purposes of payment (block 108). In those instances wherein the music is purchased from a stand alone music dispenser 28, it makes little sense to integrate the transaction into another transaction, since in all likelihood there is no such transaction in which to perform the integration (block 108A). However, in those instances where the consumer has approached an integrated music dispenser 22 such as within a fuel dispenser 26, there is an opportunity to have only one transaction occur, saving time, bandwidth required to secure external approval and the like (block 108B). Further, the transaction can be multi-stage as described in reference to FIG. 6 (block 108C).

The next variant to be determined is how music is delivered from the memory to the consumer (block 110). In particular, music may be delivered to the consumer through the antenna 60 on the building 62 (block 110A) or through the music dispenser 22 (block 110B). If provided through the music dispenser 22, the music may be broadcast from the antenna 42 or accessed through the disk drive 44. Alternatively, the music may be downloaded over a cellular network. For example, an integrated cellular phone and computer could dial a particular phone number over a cellular network and then download the desired music.

The final variant to be determined is how the consumer receives the music (block 112). Obviously this is somewhat related to how the music was delivered. For example, if the antenna 60 broadcast the music for recording, then it would be difficult to use a portable storage medium 48 to receive the music. However, the portable storage medium 48 (block 112C) could be placed in the disk drive 44 and the music could be downloaded thereto. Alternatively, the device 46 may receive a broadcast from either the antenna 60 or the antenna 42, depending on which antenna is broadcasting (block 112B). Moreover, the antenna 52 may receive the broadcast from antenna 60 or antenna 42 (block 112A). Given that a typical fueling transaction lasts approximately two minutes, it is desired that the transmission times take on the order of two minutes. Given a typical MP3 file, this is approximately 0.42 Mbytes/second. Currently, only Bluetooth technology or high speed LAN technology support this rate of data transfer, although other conventions may become available subsequent to this invention. However, multi-stage transactions eliminate some of the concern in this area, because through the use of multi-stage transactions, the vehicles may be moved out of the high traffic areas in front of the fuel dispensers 26 and still achieve music transfers. For example, car washes are substantially longer than fueling transactions, so transfer rates at the car wash music dispenser 66 do not necessarily have to be as fast as those at the fuel dispenser 26.

It should be appreciated that aspects of different variants may be combined as needed or desired, and all or some may be present within a particular fueling environment 18. The present invention may, of course, be carried out in other specific ways than those herein set forth without departing from the spirit and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A fuel dispenser comprising a user interface allowing for the purchase of music at the fuel dispenser, said fuel dispenser adapted to download the music for ultimate playback in a vehicle and including a fuel delivery path for delivery of fuel to the vehicle.

2. The fuel dispenser of claim 1 wherein said fuel dispenser downloads the music directly to a memory unit associated with the vehicle.

3. The fuel dispenser of claim 2 wherein said fuel dispenser downloads the music over a radio frequency.

4. The fuel dispenser of claim 2 wherein the music is retrieved from a location remote from the fuel dispenser prior to downloading to the vehicle.

5. The fuel dispenser of claim 1 wherein said fuel dispenser downloads the music indirectly to a memory unit associated with the vehicle.

6. The fuel dispenser of claim 5 wherein said fuel dispenser downloads the music to a portable storage medium.

7. The fuel dispenser of claim 6 wherein said portable storage medium comprises a computer readable portable storage medium.

8. The fuel dispenser of claim 5 wherein said fuel dispenser downloads the music to a playback device associated with the vehicle.

9. The fuel dispenser of claim 1 wherein said fuel dispenser begins downloading the music during an associated fueling transaction.

10. The fuel dispenser of claim 9 wherein a remote retail terminal finishes downloading the music.

11. The fuel dispenser of claim 1 wherein said fuel dispenser instructs a remote retail terminal to download the music

12. A method of vending music through a fuel dispenser comprising
accepting a consumer order at the fuel dispenser for music to be purchased; and
downloading the music to the consumer for ultimate playback in a vehicle.

13. A computer readable medium comprising software configured to run on a fuel dispenser and further adapted to accept a consumer order at the fuel dispenser for music to be purchased and download the music to the consumer for ultimate playback in a vehicle.

14. A music dispenser comprising a user interface enabling a consumer to purchase music therethrough, wherein the music is downloaded at the instigation of the music dispenser directly to an in-vehicle playback device for later playback.

15. A music dispenser comprising a user interface enabling a consumer to purchase music therethrough, wherein the music is downloaded at the instigation of the music dispenser to a consumer provided portable storage medium.

16. A music dispenser comprising a user interface enabling a consumer to purchase music therethrough, wherein the consumer may provide a playback device associated with the vehicle and the music dispenser downloads the music to the playback device.

17. A music dispenser comprising a user interface enabling a consumer to purchase music therethrough, said music dispenser configured to be positioned in a fueling environment.

18. The music dispenser of claim 17 wherein said music dispenser is associated with a fuel dispenser.

19. The music dispenser of claim 17 wherein said music dispenser is integrated into a fuel dispenser.

20. The music dispenser of claim 17 wherein said music dispenser is associated with a car wash facility within the fueling environment.

21. The music dispenser of claim 17 wherein said music dispenser is associated with a quick serve restaurant within the fueling environment.

22. The music dispenser of claim 17 wherein said music dispenser is associated with a retail terminal in a convenience store within the fueling environment.

23. A music dispenser comprising a user interface configured to enable a consumer to initiate a multistage music purchase wherein an order is initially placed at the music dispenser and at least some portion of the music is received from a retail terminal remotely positioned from the music dispenser.

24. The music dispenser of claim 23 wherein all the music purchased at the music dispenser is received from the retail terminal remotely positioned from the music dispenser.

25. A music dispenser associated with a fuel dispenser, said music dispenser comprising:
means for a consumer to purchase music, said music purchasing means associated with said fuel dispenser;
means for downloading said music to said music dispenser, said downloading means in communications with said purchasing means; and
means for transferring the music to the consumer for later playback in a vehicle, said transferring means communicating with said downloading means.

26. The music dispenser of claim 25 wherein said transferring means comprises means for transmitting the music to a device associated with the consumer for storage thereon.

27. A fueling environment comprising:
a) a plurality of fuel dispensers adapted to allow consumers to purchase fuel therefrom, said plurality of fuel dispensers positioned in a forecourt of the fueling environment;
b) one or more retail terminals positioned in the forecourt of the fueling environment;
c) a computer for storing one or more music files thereon;
d) a music dispenser associated with one of said retail terminals and operatively connected to said computer; and
e) wherein a consumer may purchase at least one of said one or more music files through the music dispenser.

28. The fueling environment of claim 26 wherein said music dispenser is integrated into one of said one or more retail sales terminals.

29. The fueling environment of claim 26 wherein said computer is remote from said fueling environment.

30. The fueling environment of claim 26 wherein said computer is located on a premises associated with the fueling environment.

31. The fueling environment of claim 29 wherein said computer is configured to communicate with a central server remote from said fueling environment.

32. The fueling environment of claim 26 wherein said music dispenser is integrated into one of said plurality of fuel dispensers.

33. The fueling environment of claim 26 wherein said at least one of said one or more music files is broadcast to a receiver.

34. The fueling environment of claim 32 wherein said receiver is a vehicle receiver.

35. The fueling environment of claim 32 wherein said receiver is a portable receiver.

36. The fueling environment of claim 32 wherein a station antenna broadcasts to the receiver.

37. The fueling environment of claim 32 wherein said music dispenser broadcasts to the receiver.

38. The fueling environment of claim 26 wherein said at least one of said one or more music files is downloaded from said music dispenser.

39. The fueling environment of claim 26 wherein said purchase is associated with a second retail transaction.

40. The fueling environment of claim 38 wherein said purchase is integrated into said second retail transaction.

41. The fueling environment of claim 26 further comprising a sales terminal operatively connected to said computer wherein a customer may purchase music at said sales terminal and receive said music at said music dispenser at a later time.

42. A method of vending music in a fueling environment, said method comprising:
providing a music dispenser in the fueling environment;
in response to a request from a consumer to purchase music at the music dispenser in the fueling environment, accessing a memory containing a plurality of music files; and
delivering at least a portion of said plurality of music files to the consumer.

43. A computer readable medium comprising software configured to operate on a music dispenser in a fueling environment, said software adapted to respond to a consumer request to purchase music by accessing memory containing a plurality of music files and delivering a requested selection to the consumer.

44. A system for retailing music is a fueling environment, said system comprising:
a) a central data storage facility including memory for storing music data files;
b) at least one fuel dispenser communicatively coupled to said central data storage facility;
c) a music transmission device associated with said at least one fuel dispenser, whereby music may be purchased by a consumer from the fuel dispenser and the music transmission device conveys the music to a device possessed by the consumer for playback.

45. A method of retailing music in a fueling environment, said method comprising:
storing music in a central data storage facility within the fueling environment;
accessing said central data storage facility from a fuel dispenser;
selling at least a portion of the music stored within said central data storage facility to a consumer through the fuel dispenser; and
conveying to the consumer said at least a portion of the music.

46. A fuel dispensing system for facilitating the purchase of music for playback in a vehicle, said comprising:
a fuel dispenser including:
fuel delivery hardware for delivering fuel to a vehicle from a storage tank;
a user interface for facilitating purchase of fuel delivered to the vehicle and music for playback in the vehicle;
a music database containing a plurality of music selections for purchase via user interface at said fuel dispenser; and
means for transferring music purchased at said user interface of said fuel dispenser in a digital format from said music database to the vehicle for subsequent playback in the vehicle.

47. A method of purchasing music for use in a vehicle during a fueling transaction, said method comprising:
displaying a plurality of music selections for purchase at a fuel dispenser interface;
receiving a customer selection for at least one of said plurality of music selections at the fuel dispenser interface;
delivering fuel to a vehicle;
accounting for the purchase of fuel delivered to the vehicle and the customer selection for the at least one of said plurality of music selections; and
providing the at least one music selection corresponding to the customer selection in a digital format that is conducive for subsequent playback in the vehicle.
